(19) United States
(12) Patent Application Publication
(10) Pub. No.: US 2017/0010461 A1
(43) Pub. Date: Jan. 12, 2017

(54) OPTICAL FIBER SCANNER, ILLUMINATOR, AND OBSERVATION APPARATUS

(71) Applicant: OLYMPUS CORPORATION, Tokyo (JP)

(72) Inventors: Yasuaki KASAI, Saitama (JP); Hiroshi TSURUTA, Kanagawa (JP); Yoshiro OKAZAKI, Tokyo (JP); Hirokazu YOKOTA, Tokyo (JP); Kazutoshi KUMAGAI, Tokyo (JP)

(73) Assignee: OLYMPUS CORPORATION, Tokyo (JP)

(21) Appl. No.: 15/275,347

(22) Filed: Sep. 24, 2016

Related U.S. Application Data
(63) Continuation of application No. PCT/JP2015/053711, filed on Feb. 10, 2015.

(30) Foreign Application Priority Data
Apr. 4, 2014 (JP) 2014-077725

(51) Int. Cl. G02B 26/10; G02B 23/24

(52) U.S. Cl. CPC G02B 26/103; G02B 23/2469

(57) ABSTRACT

An optical fiber scanner includes: an elongated optical fiber; driving piezoelectric elements that are provided on an outer circumferential surface of the optical fiber and produce bending oscillation at a distal-end portion of the optical fiber as a result of an alternating voltage being applied thereto; detecting piezoelectric elements provided on the outer circumferential surface at the distal-end portion of the optical fiber; and a control unit that controls an alternating voltage to be applied to the driving piezoelectric elements on the basis of the voltages produced by the detecting piezoelectric elements.

### CROSS-REFERENCE TO RELATED APPLICATIONS

This is a continuation of International Application PCT/JP2015/053711 which is hereby incorporated by reference herein in its entirety.

This application is based on Japanese Patent Application No. 2014-077725, the contents of which are incorporated herein by reference.

### TECHNICAL FIELD

The present invention relates to an optical fiber scanner, an illuminator, and an observation apparatus.

### BACKGROUND ART

There is a known optical fiber scanner having a tubular actuator that is composed of lead zirconate titanate (PZT) and that holds an optical fiber in a cantilevered fashion (refer to, for example, Patent Literature PTL 1 below). When an alternating voltage is applied to the actuator, it oscillates by expanding and contracting in the longitudinal direction of the optical fiber, thereby exciting a bending oscillation in the optical fiber. By doing so, a distal end of the optical fiber, which is a free end, can be oscillated to scan light emitted from the distal end.

### CITATION LIST

### Patent Literature

### {PTL 1}

PCT Japanese Translation Patent Publication No. 2008-504557

### SUMMARY OF INVENTION

### Solution to Problem

A first aspect of the present invention is an optical fiber scanner including: an elongated optical fiber that is capable of guiding light and emitting the light from a distal end thereof; a driving piezoelectric element that is provided on an outer circumferential surface of the optical fiber and that, when an alternating voltage is applied thereto, produces bending oscillation in a direction intersecting a longitudinal direction of the optical fiber at a distal-end portion of the optical fiber as a result of expanding and contracting in the longitudinal direction; a detecting piezoelectric element provided on an outer circumferential surface at the distal-end portion of the optical fiber; and a control unit that applies the alternating voltage to the driving piezoelectric element and controls the alternating voltage on the basis of a voltage produced by the detecting piezoelectric element.

### BRIEF DESCRIPTION OF DRAWINGS

FIG. 1 is an overall schematic diagram of an observation apparatus according to a first embodiment of the present invention.

FIG. 2A is a side elevational view depicting the structure of an optical fiber scanner according to the first embodiment of the present invention.

FIG. 2B is a front elevational view of the optical fiber scanner in FIG. 2A as viewed from the distal end thereof.

FIG. 3A is a side elevational view of a modification of the optical fiber scanner in FIG. 2A.

FIG. 3B is a front elevational view of the optical fiber scanner in FIG. 3A as viewed from the distal end thereof.

FIG. 4A is a side elevational view of another modification of the optical fiber scanner in FIG. 2A.

FIG. 4B is a front elevational view of the optical fiber scanner in FIG. 4A as viewed from the distal end thereof.

FIG. 5 is a side elevational view of another modification of the optical fiber scanner in FIG. 2A.

FIG. 6A is a side elevational view of another modification of the optical fiber scanner in FIG. 2A.

FIG. 6B is a front elevational view of the optical fiber scanner in FIG. 6A as viewed from the distal end thereof.

FIG. 7A is a side elevational view depicting the structure of an optical fiber scanner according to a second embodiment of the present invention.

FIG. 7B is a front elevational view of the optical fiber scanner in FIG. 7A as viewed from the distal end thereof.

FIG. 8A is a side elevational view of a modification of the optical fiber scanner in FIG. 7A.

FIG. 8B is a front elevational view of the optical fiber scanner in FIG. 8A as viewed from the distal end thereof.

FIG. 9A is a side elevational view of another modification of the optical fiber scanner in FIG. 7A.

FIG. 9B is a front elevational view of the optical fiber scanner in FIG. 9A as viewed from the distal end thereof.

FIG. 10A is a side elevational view depicting the structure of an optical fiber scanner according to a third embodiment of the present invention.

FIG. 10B is a front elevational view of the optical fiber scanner in FIG. 10A as viewed from the distal end thereof.

FIG. 11A is a side elevational view of a modification of the optical fiber scanner in FIG. 10A.

FIG. 11B is a front elevational view of the optical fiber scanner in FIG. 11A as viewed from the distal end thereof.

FIG. 12A is a side elevational view of another modification of the optical fiber scanner in FIG. 10A.

FIG. 12B is a front elevational view of the optical fiber scanner in FIG. 12A as viewed from the distal end thereof.

FIG. 13A is a side elevational view depicting the structure of an optical fiber scanner according to a fourth embodiment of the present invention.

FIG. 13B is a front elevational view of the optical fiber scanner in FIG. 13A as viewed from the distal end thereof.

FIG. 14A is a side elevational view of a modification of the optical fiber scanner in FIG. 13A.

FIG. 14B is a front elevational view of the optical fiber scanner in FIG. 14A as viewed from the distal end thereof.

FIG. 15A is a side elevational view of another modification of the optical fiber scanner in FIG. 13A.

FIG. 15B is a front elevational view of the optical fiber scanner in FIG. 15A as viewed from the distal end thereof.

### DESCRIPTION OF EMBODIMENTS

### First Embodiment

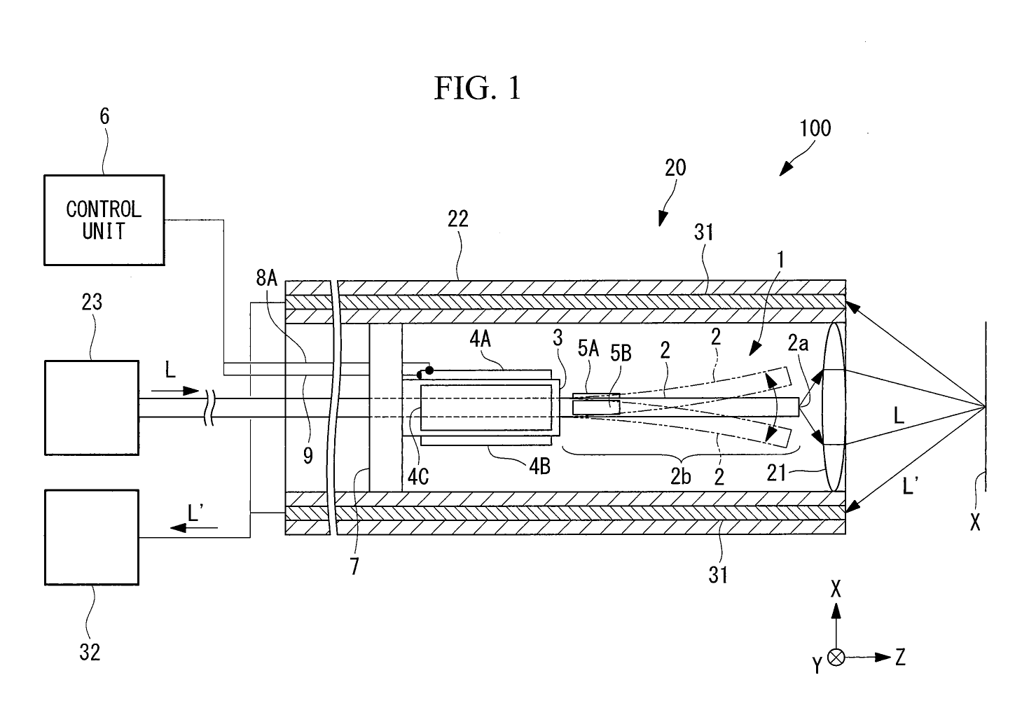

An optical fiber scanner 1, an illuminator 20, and an observation apparatus 100 according to a first embodiment of the present invention will now be described with reference to FIGS. 1 through 6B.

The observation apparatus 100 according to this embodiment is a probe-type observation apparatus, like an endoscope, and, as shown in FIG. 1, is provided with the illuminator 20 that irradiates a surface of a subject X with illumination light L and a detecting optical fiber 31 and a photodetector (light-detecting part) 32 for detecting return light L′ of the illumination light L from the subject X.

The illuminator 20 is provided with: the optical fiber scanner 1 that scans the illumination light L emitted from a distal end 2a of an optical fiber 2 by oscillating the distal end 2a; an illumination lens 21 disposed at a distal-end side of the optical fiber scanner 1; an elongated cylindrical outer cylinder 22 that accommodates the optical fiber scanner 1 and the illumination lens 21; and a light source 23 that supplies the illumination light L to a base end of the optical fiber 2.

The illumination lens 21 is disposed so that the back focal position thereof substantially coincides with the distal end 2a of the optical fiber 2 and focuses the illumination light L emitted from the distal end 2a of the optical fiber 2 onto the subject X.

The light source 23 is disposed at a base-end side of the outer cylinder 22, and the base end of the optical fiber 2 is connected to the light source 23.

A plurality of the detecting optical fibers 31 are provided in the outer cylinder 22 so as to be arranged in a circumferential direction outside the optical fiber scanner 1. The distal-end surfaces of the detecting optical fibers 31 are disposed on the distal-end surface of the outer cylinder 22.

The photodetector 32 is disposed at the base-end side of the outer cylinder 22 and is connected to the base ends of the detecting optical fibers 31.

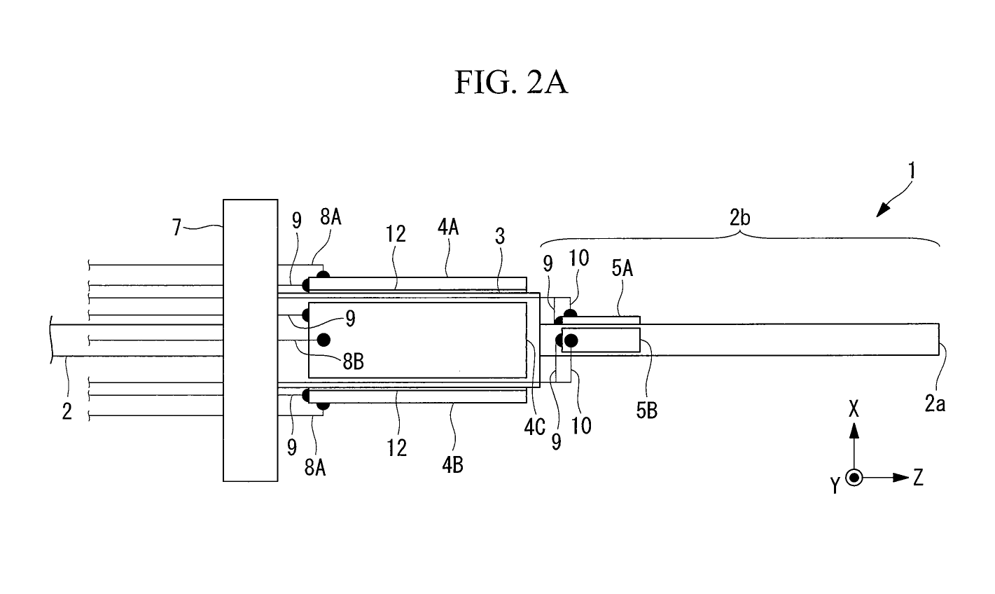

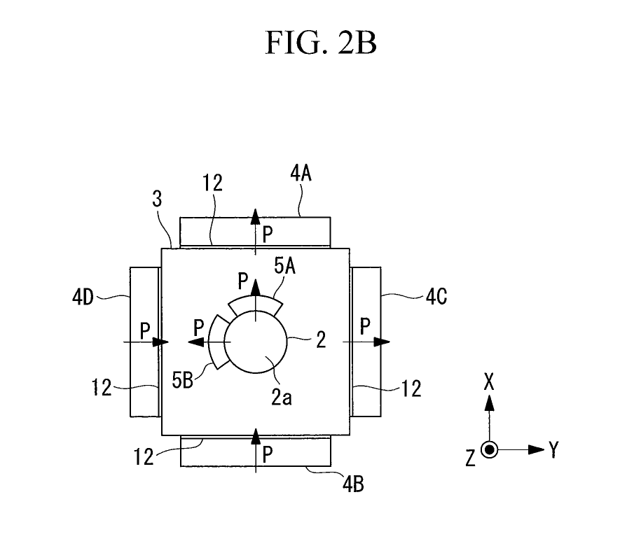

As shown in FIGS. 2A and 2B, the optical fiber scanner 1 according to this embodiment is provided with: the elongated rod-shaped optical fiber 2 composed of a glass material; an elastic member 3 oriented towards the outer circumferential surface of the optical fiber 2; four plate-shaped driving piezoelectric elements 4A, 4B, 4C, and 4D provided on the outer circumferential surface of the elastic member 3; two detecting piezoelectric elements 5A and 5B provided on the optical fiber 2; a control unit 6 that controls an alternating voltage to be applied to the driving piezoelectric elements 4A, 4B, 4C, and 4D; and a fixing member 7 for fixing the optical fiber scanner 1 to the outer cylinder 22. In the description of this embodiment, an orthogonal coordinate system X, Y, Z, in which the radial directions of the optical fiber 2 are an X direction and a Y direction and the longitudinal direction of the optical fiber 2 is a Z direction, is used.

The elastic member (oscillation-conveying part) 3 is a member shaped like a quadrangular prism composed of an electroconductive metal material such as nickel or copper. The elastic member 3 is formed along the longitudinal central axis thereof from the distal-end surface to the base-end surface and has a through-hole that close-fits with the outer circumferential surface of the optical fiber 2. The optical fiber 2 is inserted into the through-hole with the distal end thereof protruded. Hereinafter, the portion of the optical fiber 2 protruding from the elastic member 3 towards the distal end is referred to as an optical scanning section 2b.

The driving piezoelectric elements 4A, 4B, 4C, and 4D are plate-shaped members formed of a piezoelectric ceramic material such as lead zirconate titanate (PZT). The front surfaces and the back surfaces of the driving piezoelectric elements 4A, 4B, 4C, and 4D are subjected to electrode treatment so that the front surfaces become positive poles and the back surfaces become negative poles. Because of this, the driving piezoelectric elements 4A, 4B, 4C, and 4D are polarized in directions from the positive poles towards the negative poles, as shown by arrows P. The driving piezoelectric elements 4A, 4B, 4C, and 4D are bonded to the four lateral surfaces of the elastic member 3, one element to one surface, with an adhesive 12 such that the thickness directions, which are polarization directions P, are oriented along the radial direction of the optical fiber 2. The four driving piezoelectric elements 4A, 4B, 4C, and 4D are electrically insulated from the elastic member 3, for example, by using the insulating adhesive 12 or by forming the elastic member 3 from an insulating material such as zirconia.

Here, the two driving piezoelectric elements 4A and 4B, facing each other in the X direction, are bonded to the elastic member 3 so that the polarization directions P become identical. GND (ground) lead wires 9 are electrically connected to the elastic-member-3-side electrode surfaces of the driving piezoelectric elements 4A and 4B with, for example, solder or an electroconductive adhesive. Phase-A driving lead wires 8A are electrically connected to the electrode surfaces of the driving piezoelectric elements 4A and 4B, namely, the electrode surfaces on the opposite sides from the elastic member 3, with, for example, solder or an electroconductive adhesive. When a phase-A alternating voltage is applied to the driving piezoelectric elements 4A and 4B from the control unit 6 through the driving lead wires 8A, the driving piezoelectric elements 4A and 4B oscillate by expanding and contracting in the Z direction orthogonal to the polarization directions P. At this time, one of the two driving piezoelectric elements 4A and 4B contracts in the Z direction and the other extends in the Z direction, thereby causing the elastic member 3 to undergo a bending oscillation in the X direction. As a result of this bending oscillation of the elastic member 3 in the X direction being transmitted to the optical fiber 2, the optical scanning section 2b of the optical fiber 2 undergoes a bending oscillation in the X direction, allowing the distal end 2a of the optical fiber 2 to perform linear oscillation in the X direction.

Similarly, the two driving piezoelectric elements 4C and 4D facing each other in the Y direction are bonded to the elastic member 3 so that the polarization directions P become identical. GND lead wires 9 are electrically connected to the elastic-member-3-side electrode surfaces of the driving piezoelectric elements 4C and 4D with, for example, solder or an electroconductive adhesive. Phase-B driving lead wires 8B are electrically connected to the electrode surfaces of the driving piezoelectric elements 4C and 4D, namely the electrode surfaces on the opposite sides from the elastic member 3, with, for example, solder or an electroconductive adhesive. When a phase-B alternating voltage is applied to the driving piezoelectric elements 4C and 4D from the control unit 6 through the driving lead wires 8B, the driving piezoelectric elements 4C and 4D oscillate by expanding and contracting in the Z direction orthogonal to the polarization directions P. At this time, one of the two driving piezoelectric elements 4C and 4D contracts in the Z direction and the other extends in the Z direction, thereby causing the elastic member 3 to undergo a bending oscillation in the Y direction. As a result of this bending oscillation of the elastic member 3 in the Y direction being transmitted to the optical fiber 2, the optical scanning section 2b of the optical fiber 2 undergoes a bending oscillation in the Y direction, allowing the distal end 2a of the optical fiber 2 to perform linear oscillation in the Y direction.

Like the driving piezoelectric elements 4A, 4B, 4C, and 4D, the detecting piezoelectric elements 5A and 5B are plate-shaped members formed of a piezoelectric ceramic material such as PZT and are polarized in the thickness directions. The detecting piezoelectric element 5A on one hand is provided at one of two positions on the outer circumferential surface of the optical scanning section 2b, namely, the two positions facing each other in the X direction with the central axis of the optical scanning section 2b therebetween, and is bonded to the outer circumferential surface of the optical scanning section 2b with an electroconductive adhesive. The detecting piezoelectric element 5B on the other hand is provided at one of two positions on the outer circumferential surface of the optical scanning section 2b, namely, the two positions facing each other in the Y direction with the central axis of the optical scanning section 2b therebetween, and is bonded to the outer circumferential surface of the optical scanning section 2b with an electroconductive adhesive.

GND lead wires 9 are electrically connected to the optical-scanning-section-2b-side electrode surfaces of the detecting piezoelectric elements 5A and 5B with, for example, solder or an electroconductive adhesive. Detecting lead wires 10 are electrically connected to the electrode surfaces of the detecting piezoelectric elements 5A and 5B, namely, the electrode surfaces on the opposite sides from the optical scanning section 2b, with, for example, solder or an electroconductive adhesive.

Note that the detecting piezoelectric elements 5A and 5B may be composed of a film of a piezoelectric ceramic material formed on the outer circumferential surface of the optical scanning section 2b by, for example, the aerosol deposition method (AD method).

The lead wires 8A, 8B, 9, and 10 are routed substantially along the outer circumferential surface of the optical fiber 2 via gaps in the piezoelectric elements 4 and 5 or a through-hole (not shown in the figure) formed in the fixing member 7 along the Z direction and are bundled together on the base end of the fixing member 7. Of the lead wires 8A, 8B, 9, and 10, FIG. 1 illustrates only the lead wires 8A and 9 connected to the driving piezoelectric element 4A to prevent the drawing from becoming complicated.

The control unit 6 has a GND terminal, and the GND lead wires 9 of all the piezoelectric elements 4A, 4B, 4C, 4D, 5A, and 5B are connected to the common GND terminal. Because of this, the driving lead wires 8A and 8B and the detecting lead wires 10 have electrically positive polarity.

The driving lead wires 8A and 8B and the detecting lead wires 10 are connected to the control unit 6. The control unit 6 applies an alternating voltage of a predetermined setting to the driving piezoelectric elements 4A, 4B, 4C, and 4D via the driving lead wires 8A and 8B. Furthermore, after the application of the alternating voltage of a predetermined setting, the control unit 6 controls the alternating voltage on the basis of the voltages of the detecting piezoelectric elements 5A and 5B detected via the detecting lead wires 10.

More specifically, when the detecting piezoelectric elements 5A and 5B are deformed as a result of bending oscillation of the optical scanning section 2b, the detecting piezoelectric elements 5A and 5B produce periodically oscillating voltages by the piezoelectric effect. The produced voltages (hereinafter, referred to as detected voltages) are detected by the control unit 6 via the detecting lead wires 10.

The control unit 6 compares the phase between the phase-A alternating voltage previously applied to the driving piezoelectric elements 4A and 4B and the voltage detected by the detecting piezoelectric element 5A and adjusts the phase of the phase-A alternating voltage so that the phase difference becomes equal to a predetermined target value. Furthermore, the control unit 6 adjusts the amplitude of the phase-A alternating voltage so that the amplitude of the detecting piezoelectric element 5A becomes equal to a predetermined target value.

Similarly, the control unit 6 compares the phase between the phase-B alternating voltage previously applied to the driving piezoelectric elements 4C and 4D and the voltage detected by the detecting piezoelectric element 5B and adjusts the phase of the phase-B alternating voltage so that the phase difference becomes equal to a predetermined target value. Furthermore, the control unit 6 adjusts the amplitude of the phase-B alternating voltage so that the amplitude of the detecting piezoelectric element 5B becomes equal to a predetermined target value.

The fixing member 7 is a cylindrical member formed of a metal material such as stainless steel. The inner circumferential surface of the fixing member 7 is firmly bonded to the outer circumferential surface of the optical fiber 2 at the base end of the elastic member 3. The outer circumferential surface of the fixing member 7 is fixed to the inner circumferential surface of the outer cylinder 22 with an epoxy-based adhesive.

The operations of the optical fiber scanner 1, the illuminator 20, and the observation apparatus 100 with the above-described structures will now be described.

In order to observe the subject X using the observation apparatus 100 according to this embodiment, the illumination light L is supplied from the light source 23 to the optical fiber 2 while the illumination lens 21 is disposed to face the subject X, and the distal end 2a of the optical fiber 2 is then oscillated to scan the illumination light L over the subject X.

More specifically, a phase-A alternating voltage having a frequency corresponding to the bending-oscillation resonance frequency of the optical scanning section 2b is applied to the driving piezoelectric elements 4A and 4B via the driving lead wires 8A. By doing so, a bending oscillation in the X direction is excited in the optical scanning section 2b, and the illumination light L emitted from the distal end 2a of the optical fiber 2 is linearly scanned in the X direction. Similarly, a phase-B alternating voltage having a frequency corresponding to the bending-oscillation resonance frequency of the optical scanning section 2b is applied to the driving piezoelectric elements 4C and 4D via the driving lead wires 8B. By doing so, bending oscillation in the Y direction is excited in the optical scanning section 2b, and the illumination light L emitted from the distal end 2a of the optical fiber 2 is linearly scanned in the Y direction.

Here, by shifting the phase of the phase-A alternating voltage and the phase of the phase-B alternating voltage from each other by n/2, the distal end 2a of the optical fiber 2 oscillates along a circular trajectory. Furthermore, by changing the amplitudes of the phase-A alternating voltage and the phase-B alternating voltage in this state so as to form a sine wave, the distal end 2a of the optical fiber 2 oscillates along a spiral trajectory.

The illumination light L emitted from the distal end 2a of the optical fiber 2 is focused by the illumination lens 21 onto the subject X and is scanned two-dimensionally along a spiral trajectory over the subject X. The return light L′ of the illumination light L from the subject X is received by the plurality of detecting optical fibers 31 and its intensity is detected by the photodetector 32. The observation apparatus 100 detects the return light L′ using the photodetector 32 in synchronization with the scanning period of the illumination light L and generates an image of the subject X by associating the intensity of the detected return light L′ with the scanning position of the illumination light L.

In this case, if a mechanical property of the optical scanning section 2b changes due to, for example, a temperature change or deterioration over time, causing the oscillation state of the optical scanning section 2b to change, that change in the oscillation state of the optical scanning section 2b is immediately detected by the control unit 6 as a change in the oscillation state of the detected voltages produced by the detecting piezoelectric elements 5A and 5B. Thereafter, the phases and the amplitudes of the alternating voltages are feedback-controlled by the control unit 6 so that the phase delays of the detected voltages relative to the alternating voltages supplied to the driving piezoelectric elements 4A, 4B, 4C, and 4D and the amplitudes of the detected voltages are respective target values. Thus, an advantage is afforded in that the oscillation state of the optical scanning section 2b can be retained constant to continue scanning the illumination light L along a desired scanning trajectory by detecting the actual oscillation state of the optical scanning section 2b and controlling the alternating voltages so that they approach the states intended by the oscillation state of the optical scanning section 2b on the basis of the detection results.

In this embodiment, if the oscillation state of the optical scanning section 2b does not enter an intended state even after a predetermined period of time has elapsed since the start of adjustment of the alternating voltages, the control unit 6 may stop applying an alternating voltage to the driving piezoelectric elements 4A, 4B, 4C, and 4D and may also stop outputting the illumination light L from the light source 23.

Damage to the optical fiber 2 also causes the oscillation state of the optical fiber 2 to change. For example, if the optical fiber 2 is broken, the amplitude of the optical fiber 2 becomes small, also decreasing the amplitudes of the voltages detected by the detecting piezoelectric elements 5A and 5B. In such a case, it is difficult to recover the oscillation state of the optical fiber 2 to a target state by adjusting the alternating voltages. Therefore, if an oscillation state in which the optical scanning section 2b is not normal is still detected even after alternating voltages have been adjusted by the control unit 6, damage to the optical fiber 2 can be detected.

Although, in this embodiment, the driving piezoelectric elements 4A, 4B, 4C, and 4D are bonded to the outer circumferential surfaces of the elastic member 3 shaped like a square column, the specific structure of the optical fiber scanner 1 is not limited to this.

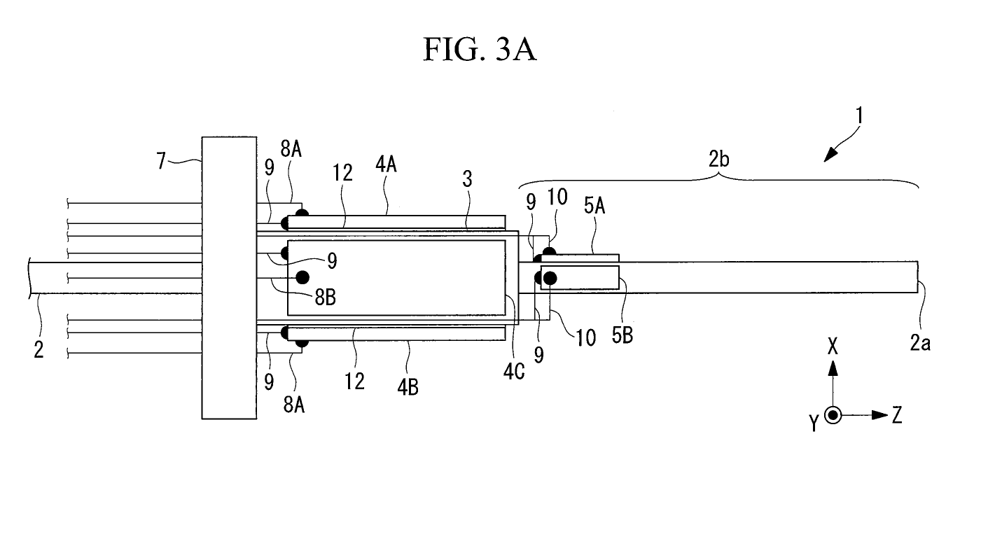

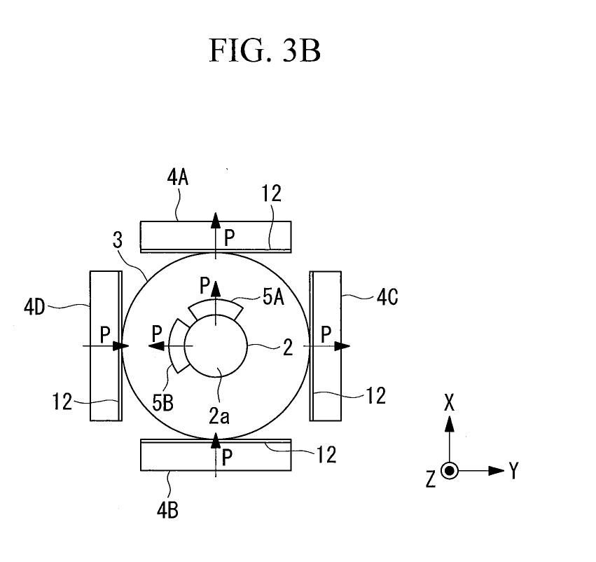

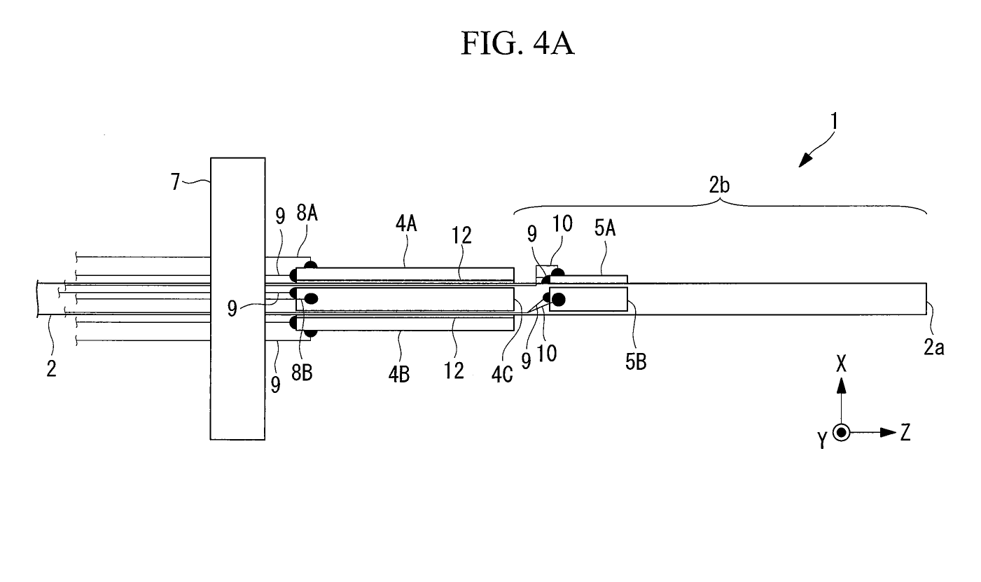

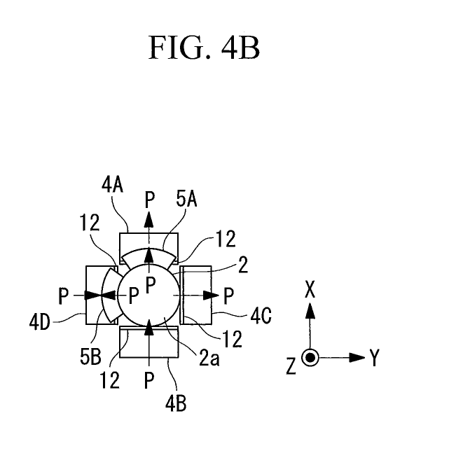

The elastic member 3 may be, for example, cylindrical, as shown in FIGS. 3A and 3B. Alternatively, the driving piezoelectric elements 4A, 4B, 4C, and 4D may be bonded directly to the outer circumferential surface of the optical fiber 2 by omitting the elastic member 3, as shown in FIGS. 4A and B.

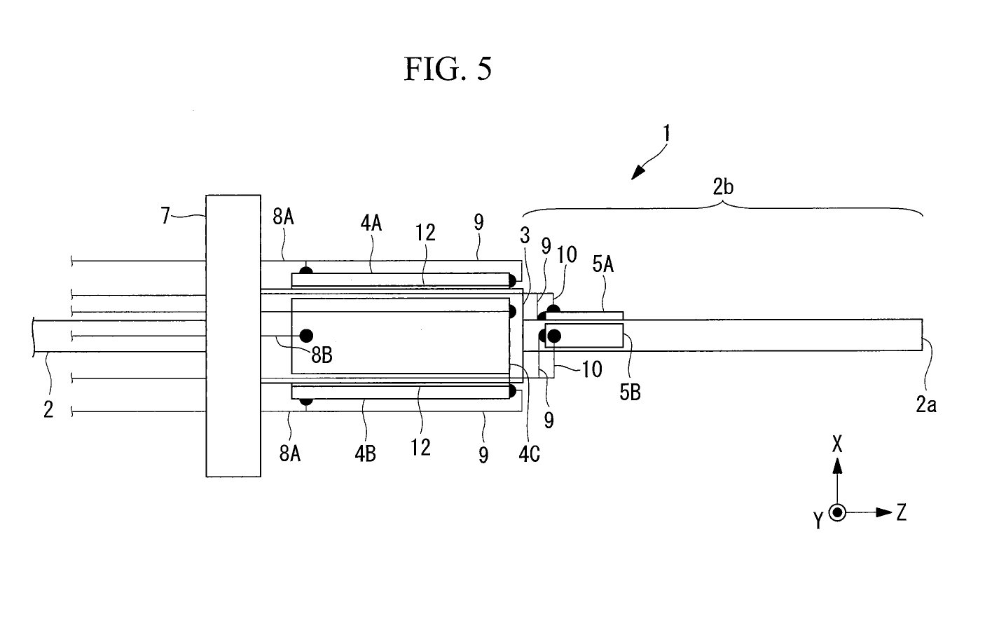

In this embodiment, the connection points of the GND lead wires 9 of the driving piezoelectric elements 4A, 4B, 4C, and 4D may be changed, as appropriate. For example, the GND lead wires 9 may be connected to distal-end lateral surfaces of the driving piezoelectric elements 4A, 4B, 4C, and 4D, as shown in FIG. 5.

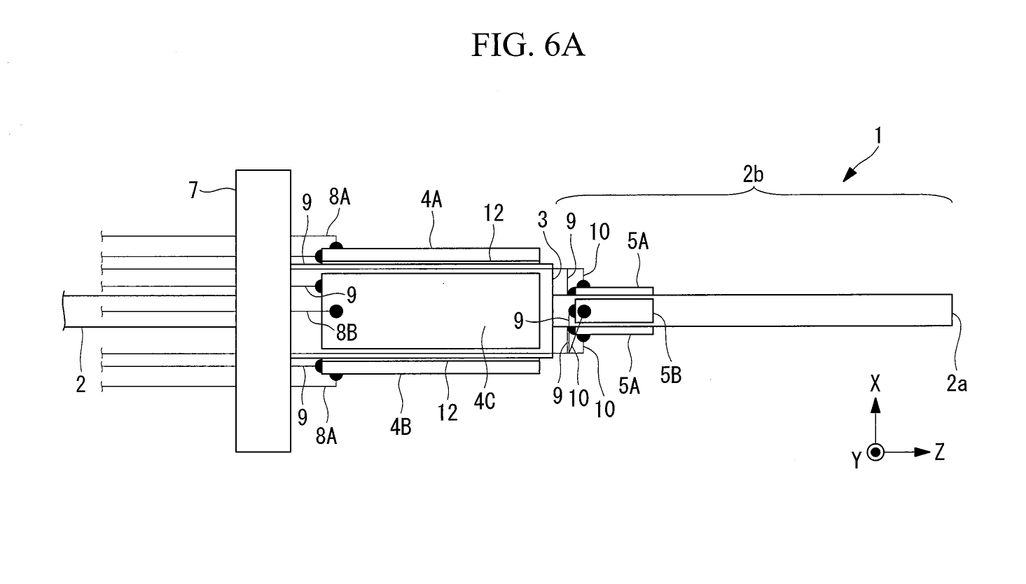

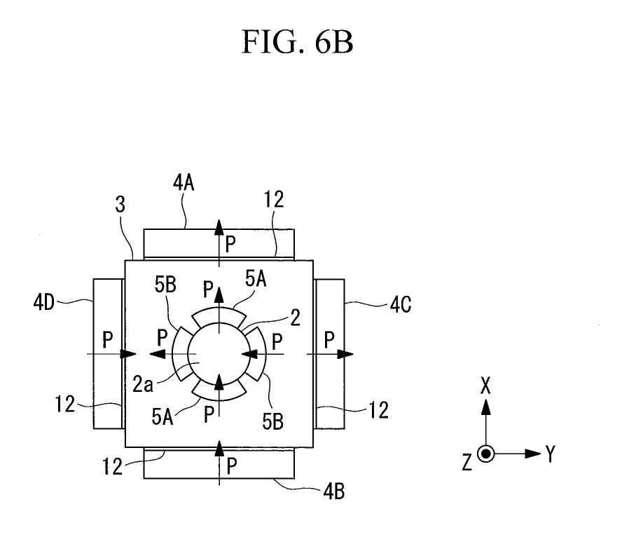

Although, in this embodiment, one detecting piezoelectric element 5A for oscillation detection in the X direction and one detecting piezoelectric element 5B for oscillation detection in the Y direction are provided, two elements 5A and two elements 5B may be provided, as shown in FIGS. 6A and 6B. In this case, the two detecting piezoelectric elements 5A are provided at two positions on the outer circumferential surface of the optical scanning section 2b, namely, the two positions facing each other in the X direction, and the two detecting piezoelectric elements 5B are provided at two positions on the outer circumferential surface of the optical scanning section 2b, namely, the two positions facing each other in the Y direction.

By doing so, the oscillation state in the X direction of the optical scanning section 2b is detected as a differential voltage between the voltages generated by the two detecting piezoelectric elements 5A, and the oscillation state in the Y direction of the optical scanning section 2b is detected as a differential voltage between the voltages generated by the two detecting piezoelectric elements 5B. As a result, the oscillation state of the optical scanning section 2b in each direction can be detected at even higher sensitivity.

### Second Embodiment

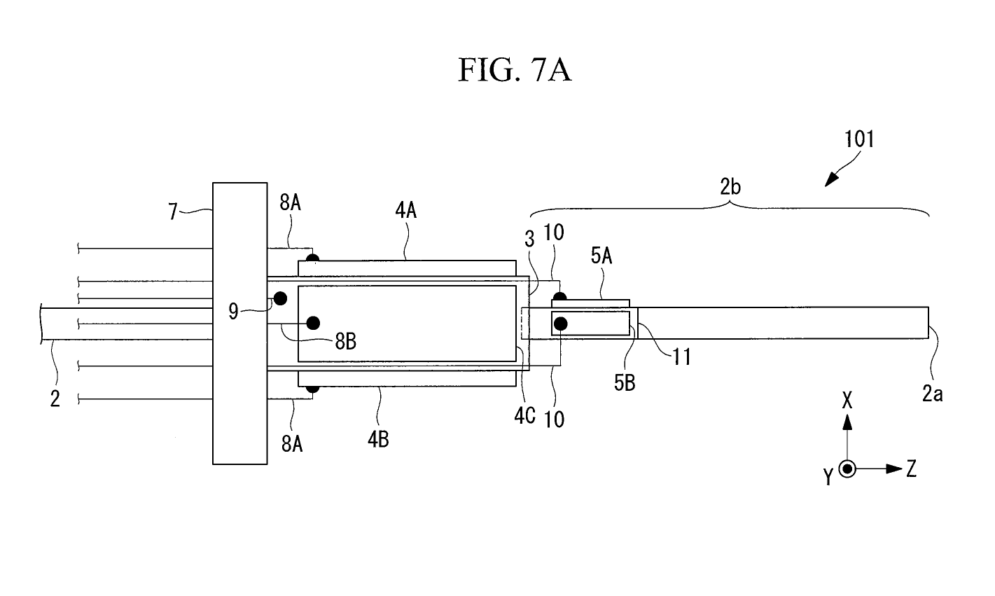

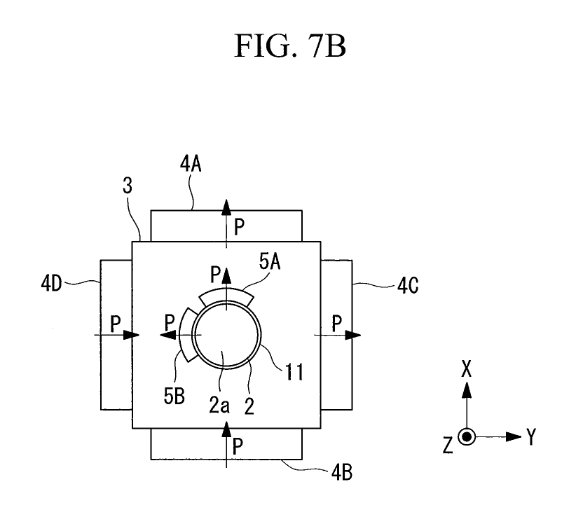

An optical fiber scanner 101, an illuminator, and an observation apparatus according to a second embodiment of the present invention will now be described with reference to FIGS. 7A to 9B.

The illuminator and the observation apparatus according to this embodiment are configured by replacing the optical fiber scanner 1 in the illuminator 20 and the observation apparatus 100 of FIG. 1 with the optical fiber scanner 101.

As shown in FIGS. 7A and 7B, the optical fiber scanner 101 according to this embodiment differs from the first embodiment mainly in that an electroconductive part 11 is provided between the optical scanning section 2b and the detecting piezoelectric elements 5A and 5B. For this reason, in this embodiment, the electroconductive part 11 is mainly described, and structures that are the same as in the first embodiment are denoted with same reference signs, and a description thereof is omitted.

The electroconductive part 11 is a tubular member provided on the outer circumferential surface at a base-end portion of the optical scanning section 2b and is made of an electroconductive metal material. The electroconductive part 11 is formed by, for example, applying a conductive film coating such as electrolytic or non-electrolytic plating, or alternatively, by applying an electroconductive adhesive to the outer circumferential surface of the optical scanning section 2b. The detecting piezoelectric elements 5A and 5B are fixed to the outer circumferential surface of the electroconductive part 11 with an electroconductive adhesive. A base-end part of the electroconductive part 11 is inserted between the optical fiber 2 and the elastic member 3, and the electroconductive part 11 and the elastic member 3 are fixed with an electroconductive adhesive. Because of this, the elastic member 3 functions as a common GND for the four driving piezoelectric elements 4A, 4B, 4C, and 4D and the two detecting piezoelectric elements 5A and 5B, and a single GND lead wire 9 is connected to the elastic member 3.

The operations of the optical fiber scanner 101, the illuminator, and the observation apparatus according to this embodiment are the same as those in the first embodiment, and a description thereof will be omitted.

As described above, this embodiment affords an advantage in that by providing the electroconductive part 11 disposed between the outer circumferential surface of the optical fiber 2 and the piezoelectric elements 4A, 4B, 4C, 4D, 5A, and 5B and by electrically connecting the electroconductive part 11 to all the piezoelectric elements 4A, 4B, 4C, 4D, 5A, and 5B, one GND lead wire 9 alone can suffice for all the piezoelectric elements 4A, 4B, 4C, 4D, 5A, and 5B. The other advantages of this embodiment are the same as in the first embodiment, and a description thereof will be omitted.

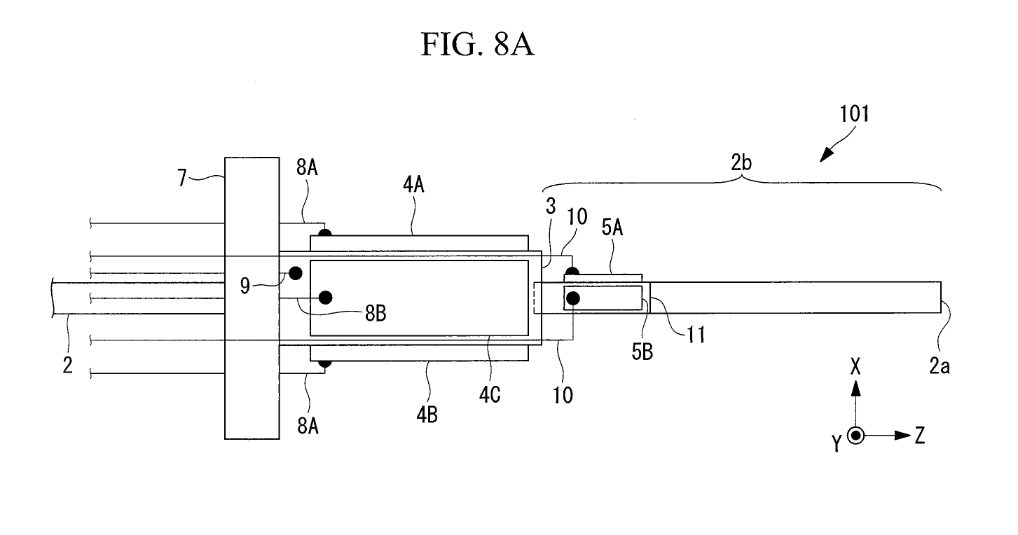

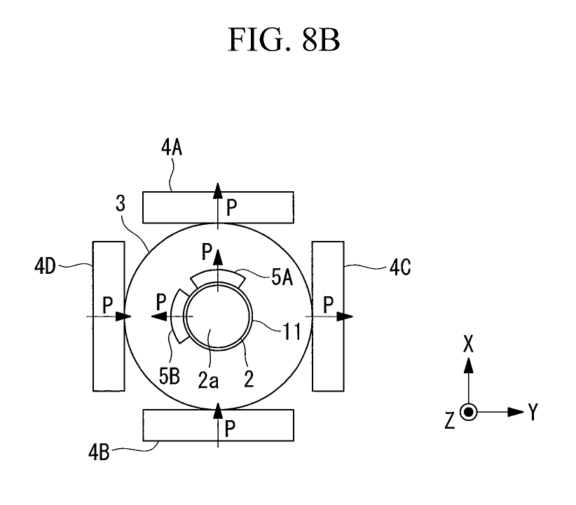

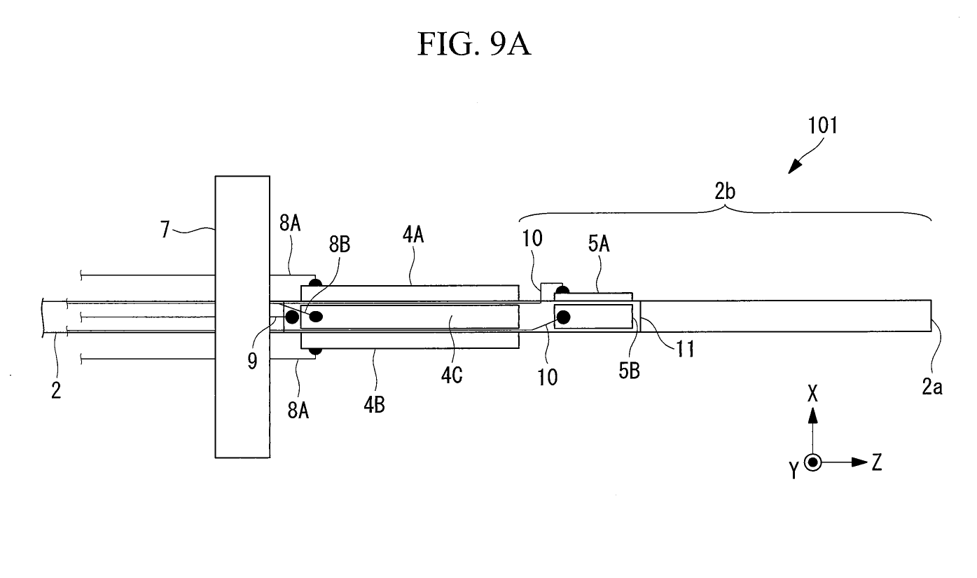

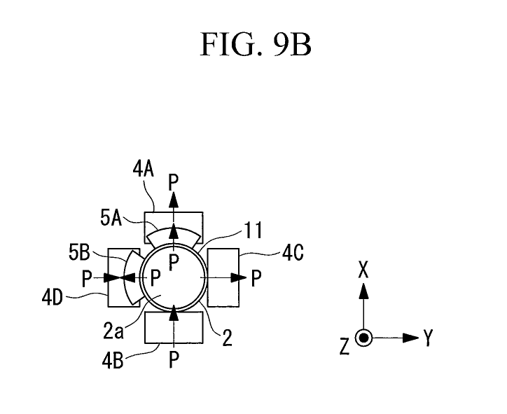

Also in this embodiment, the cylindrical elastic member 3 may be employed, as shown in FIGS. 8A and 8B, and furthermore, the driving piezoelectric elements 4A, 4B, 4C, and 4D may be attached directly to the outer circumferential surface of the optical fiber 2 by omitting the elastic member 3, as shown in FIGS. 9A and 9B.

### Third Embodiment

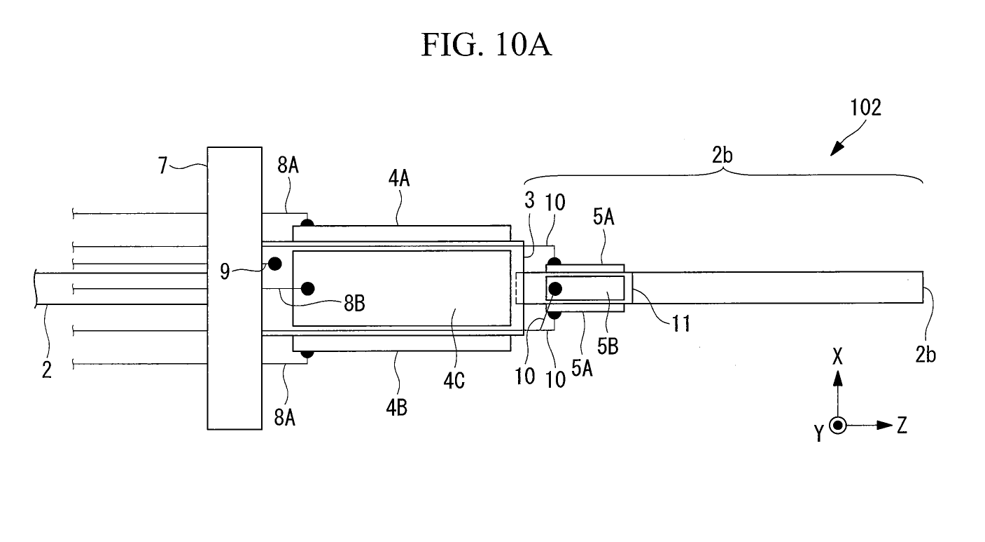

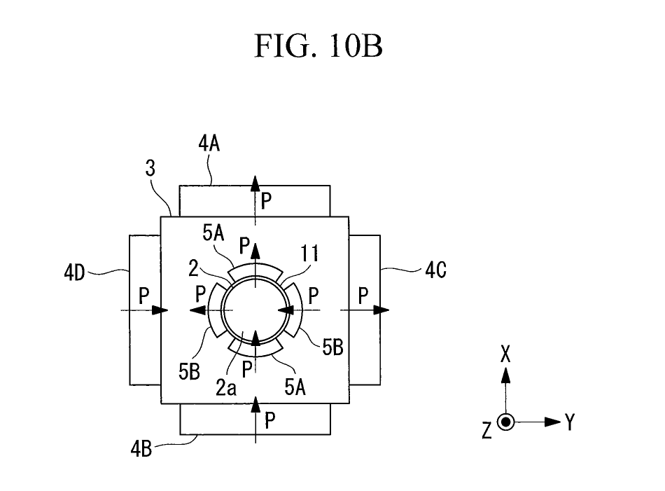

An optical fiber scanner 102, an illuminator, and an observation apparatus according to a third embodiment of the present invention will now be described with reference to FIGS. 10A to 12B.

An illuminator and an observation apparatus according to this embodiment are configured by replacing the optical fiber scanner 1 in the illuminator 20 and the observation apparatus 100 of FIG. 1 with the optical fiber scanner 102.

As shown in FIGS. 10A and 10B, the optical fiber scanner 102 according to this embodiment is provided with the above-described electroconductive part 11 and differs from the first and second embodiments mainly in that two detecting piezoelectric elements 5A and 5B are further provided. For this reason, in this embodiment, the detecting piezoelectric elements 5A and 5B are mainly described, and structures that are the same as in the first and second embodiments are denoted with same reference signs, and a description thereof is omitted.

The optical fiber scanner 102 according to this embodiment includes the two detecting piezoelectric elements 5A for oscillation detection in the X direction and includes the two detecting piezoelectric elements 5B for oscillation detection in the Y direction. The two detecting piezoelectric elements 5A are provided on the outer circumferential surface of the optical scanning section 2b so as to face each other in the X direction. The two detecting piezoelectric elements 5B are provided on the outer circumferential surface of the optical scanning section 2b so as to face each other in the Y direction.

According to the optical fiber scanner 102 with this structure, the oscillation state in the X direction of the optical scanning section 2b is detected as a differential voltage between the voltages generated by the two detecting piezoelectric elements 5A, and the oscillation state in the Y direction of the optical scanning section 2b is detected as a differential voltage between the voltages generated by the two detecting piezoelectric elements 5B. Because of this, an advantage is afforded in that the oscillation state of the optical scanning section 2b in each direction can be detected with even higher sensitivity, thereby allowing the control unit 6 to adjust an alternating voltage in each phase even more appropriately.

The other operations and advantages of the optical fiber scanner 102, the illuminator, and the observation apparatus according to this embodiment are the same as in the first embodiment, and a description thereof will be omitted.

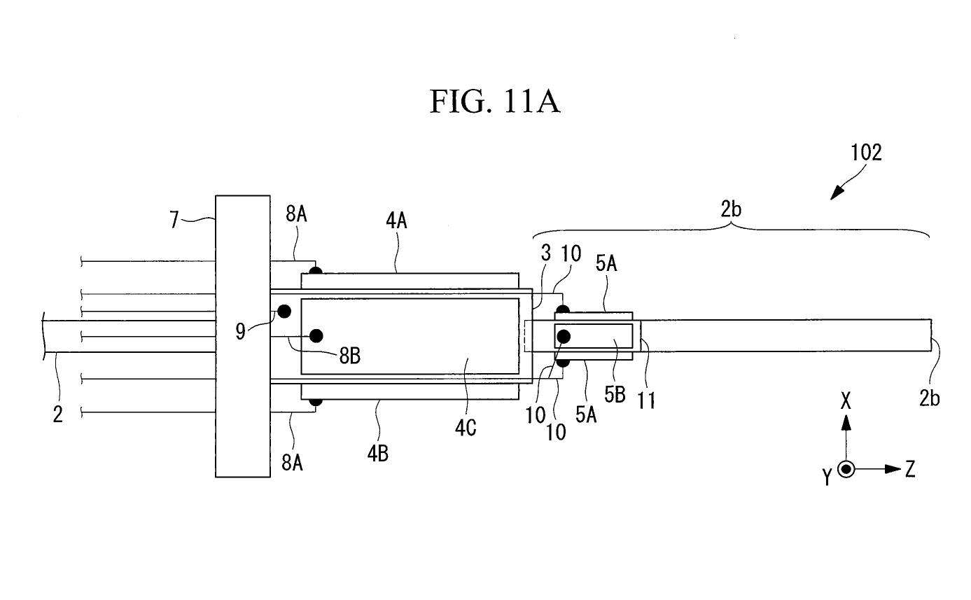

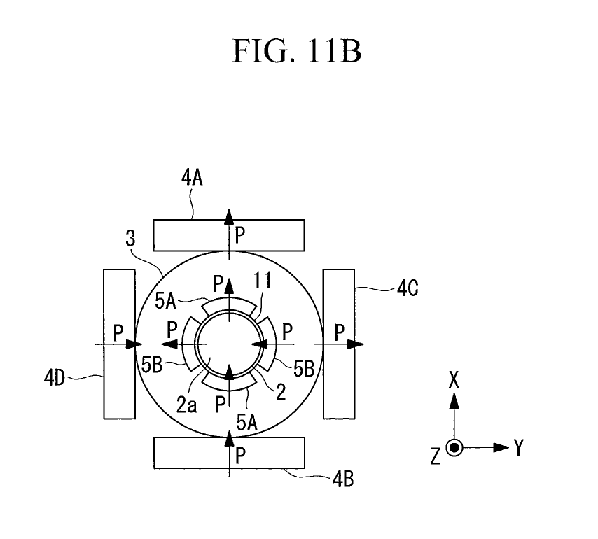

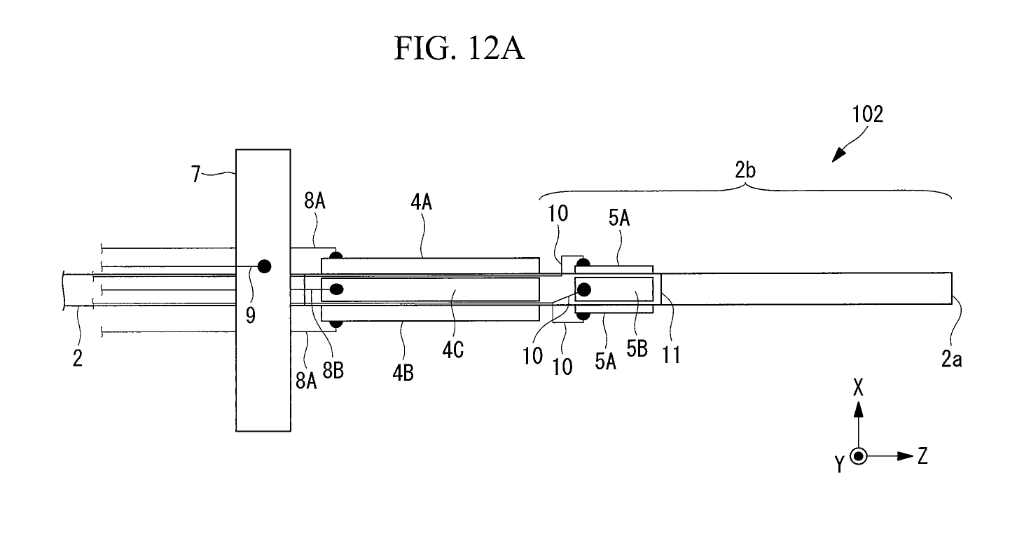

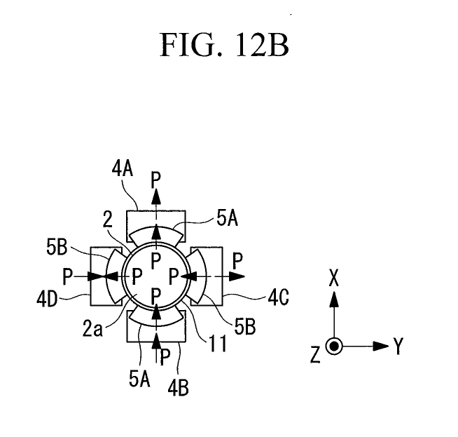

Also in this embodiment, the cylindrical elastic member 3 may be employed, as shown in FIGS. 11A and 11B, and the driving piezoelectric elements 4A, 4B, 4C, and 4D may be attached directly to the outer circumferential surface of the optical fiber 2 by omitting the elastic member 3, as shown in FIGS. 12A and 12B.

### Fourth Embodiment

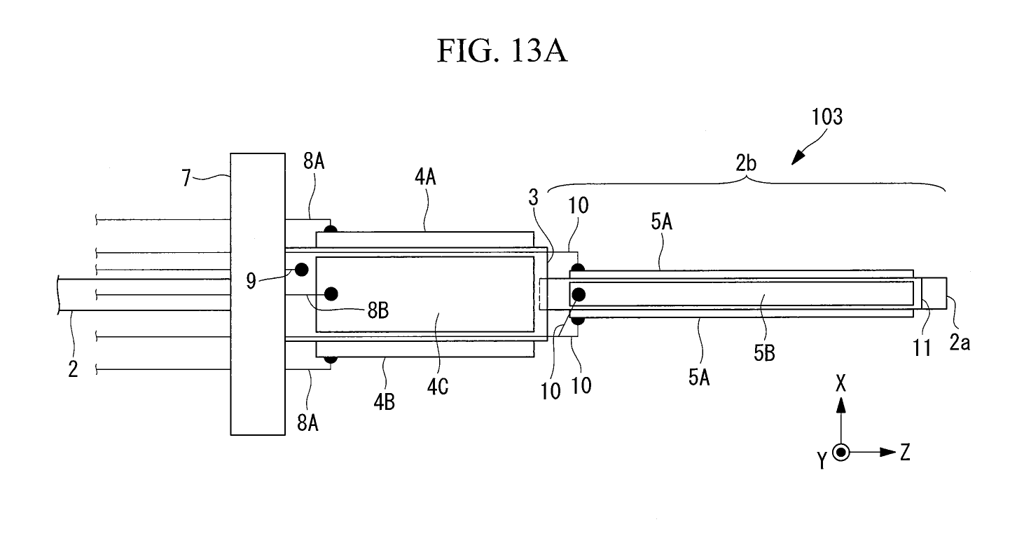

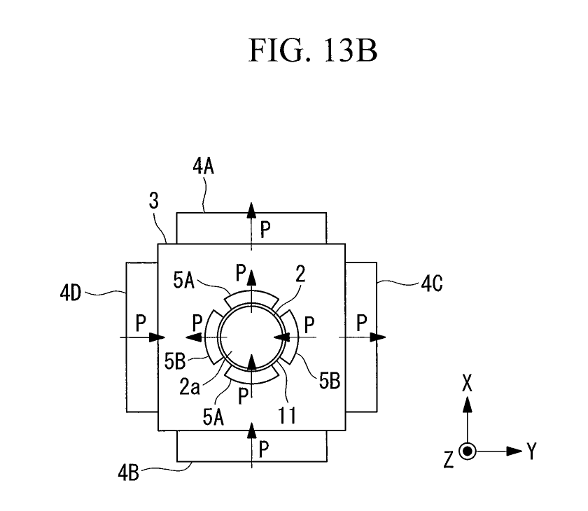

An optical fiber scanner 103, an illuminator, and an observation apparatus according to a fourth embodiment of the present invention will now be described with reference to FIGS. 13A to 15B.

The illuminator and the observation apparatus according to this embodiment are configured by replacing the optical fiber scanner 1 in the illuminator 20 and the observation apparatus 100 of FIG. 1 with the optical fiber scanner 102.

The optical fiber scanner 103 according to this embodiment is formed by modifying the optical fiber scanner 102 of the third embodiment, as shown in FIGS. 13A and 13B, and differs from the third embodiment in that the electroconductive part 11 and the detecting piezoelectric elements 5A and 5B are provided over approximately the entire length of the optical scanning section 2b. For this reason, in this embodiment, the electroconductive part 11 and the detecting piezoelectric elements 5A and 5B are mainly described, and structures that are the same as in the first to third embodiments are denoted with same reference signs, and a description thereof is omitted.

According to the optical fiber scanner 103 with this structure, since the area of contact of the detecting piezoelectric elements 5A and 5B with the optical scanning section 2b becomes large, the deformation levels of the individual detecting piezoelectric elements 5A and 5B resulting from bending oscillation of the optical scanning section 2b become large, thereby causing the amplitudes of voltages generated by the individual detecting piezoelectric elements 5A and 5B to become large, accordingly. This affords an advantage in that the oscillation state of the optical scanning section 2b can be detected with even higher sensitivity.

The other operations and advantages of the optical fiber scanner 103, the illuminator, and the observation apparatus according to this embodiment are the same as in the first to third embodiments, and a description thereof will be omitted.

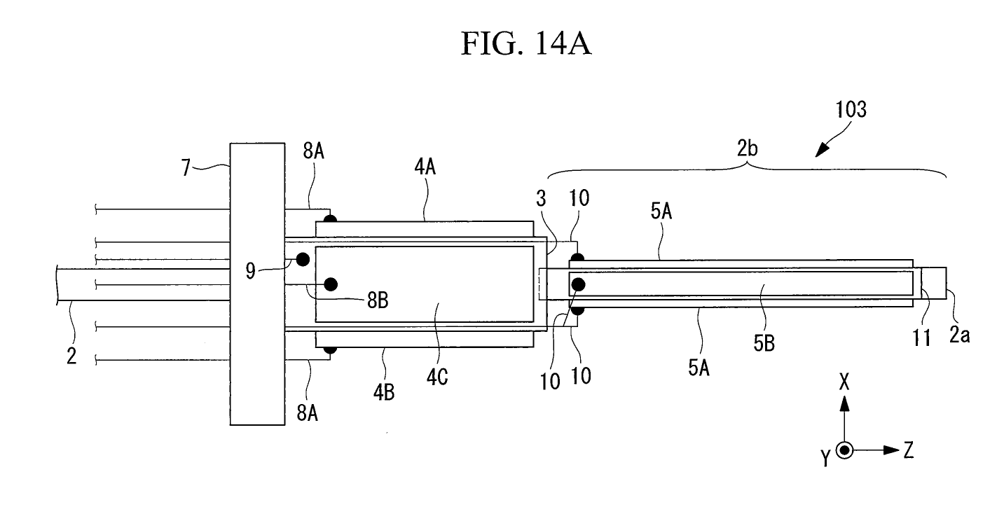

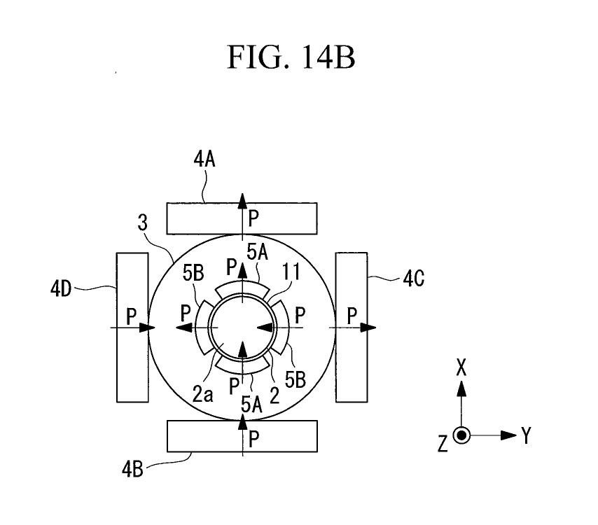

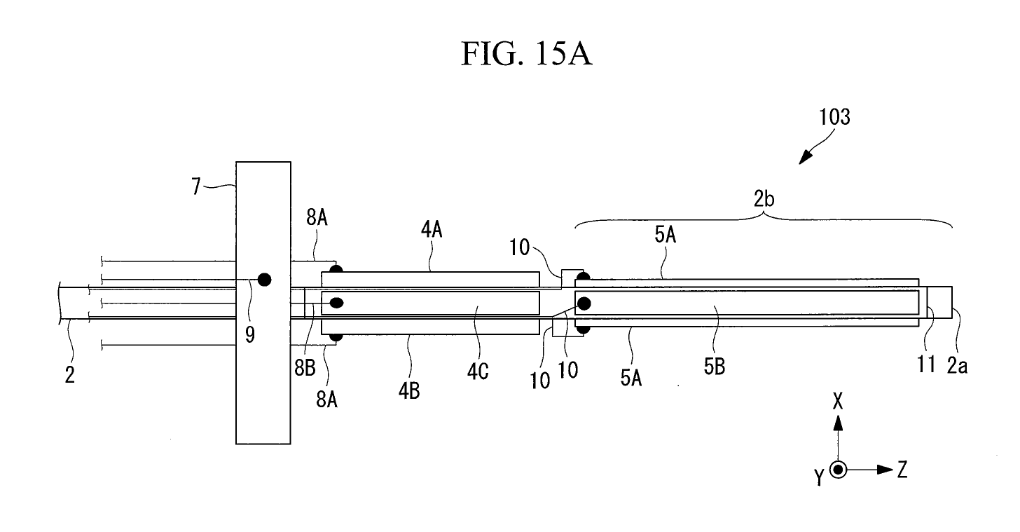

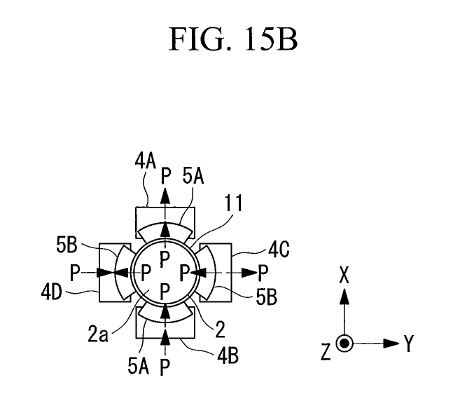

Also in this embodiment, the cylindrical elastic member 3 may be employed, as shown in FIGS. 14A and 14B, and the driving piezoelectric elements 4A, 4B, 4C, and 4D may be attached directly to the outer circumferential surface of the optical fiber 2 by omitting the elastic member 3, as shown in FIGS. 15A and 15B.

The above-described embodiment leads to the following inventions.

A first aspect of the present invention is an optical fiber scanner including: an elongated optical fiber that is capable of guiding light and emitting the light from a distal end thereof; a driving piezoelectric element that is provided on an outer circumferential surface of the optical fiber and that, when an alternating voltage is applied thereto, produces bending oscillation in a direction intersecting a longitudinal direction of the optical fiber at a distal-end portion of the optical fiber as a result of expanding and contracting in the longitudinal direction; a detecting piezoelectric element provided on an outer circumferential surface at the distal-end portion of the optical fiber; and a control unit that applies the alternating voltage to the driving piezoelectric element and controls the alternating voltage on the basis of a voltage produced by the detecting piezoelectric element.

According to the first aspect of the present invention, when an alternating voltage is applied to the piezoelectric element, expansion/contraction oscillation of the piezoelectric element excites bending oscillation at the distal-end portion of the optical fiber, thereby causing the distal end of the optical fiber to oscillate in the lateral direction thereof. Because of this, illumination light emitted from the distal end of the optical fiber can be scanned.

In this case, the detecting piezoelectric element is deformed as a result of bending oscillation of the distal-end portion of the optical fiber, and this detecting piezoelectric element produces a voltage that oscillates in response to the bending oscillation of the distal-end portion of the optical fiber.

The control unit controls the alternating voltage to be applied to the driving piezoelectric element so that the oscillation state of the voltage produced by the detecting piezoelectric element becomes a predetermined state, namely, so that the oscillation state of the distal-end portion of the optical fiber becomes a predetermined state. By doing so, even if a mechanical property of a component, such as the optical fiber and the piezoelectric element, is subject to change, the oscillation state of the distal-end portion of the optical fiber can be kept constant, thereby allowing light to be scanned along a desired trajectory.

In the above-described first aspect, the detecting piezoelectric element may be provided at at least one of two positions on the outer circumferential surface of the optical fiber, the two positions facing each other in a direction in which the distal-end portion undergoes the bending oscillation.

By doing so, the oscillation of the voltage produced by the detecting piezoelectric element becomes more approximate to bending oscillation of the distal-end portion of the optical fiber, allowing the oscillation state of the optical fiber to be detected at even higher sensitivity.

In the above-described first aspect, a pair of the detecting piezoelectric elements may be provided at both of the two positions.

By doing so, oscillation state of the optical fiber can be detected at even higher sensitivity on the basis of a differential voltage between the voltages produced by the pair of detecting piezoelectric elements.

In the above-described first aspect, an oscillation-conveying part composed of a tubular elastomer provided between the outer circumferential surface of the optical fiber and the driving piezoelectric element may be provided.

By doing so, expansion/contraction oscillation of the piezoelectric element can be efficiently transmitted to the optical fiber by the oscillation-conveying part.

In the above-described first aspect, a tubular electroconductive part that is provided between the outer circumferential surface at the distal-end portion of the optical fiber and the driving and detecting piezoelectric elements and that is electrically connected to the driving piezoelectric element and the detecting piezoelectric element may be provided.

By doing so, because the electroconductive part functions as a common GND (ground) electrode for the driving piezoelectric element and the detecting piezoelectric element, the number of GND lead wires can be reduced to one.

In the above-described first aspect, the detecting piezoelectric element may be provided over substantially the entire length of the distal-end portion.

By doing so, because the voltage produced by the detecting piezoelectric element along with bending oscillation of the distal-end portion of the optical fiber becomes high, the oscillation state of the distal-end portion of the optical fiber can be detected at even higher sensitivity.

A second aspect of the present invention is an illuminator including: any of the above-described optical fiber scanners; a light source that is disposed at a base-end side of the optical fiber scanner and supplies illumination light to the optical fiber; an illumination lens that is disposed at a distal-end side of the optical fiber scanner and focuses the illumination light emitted from the distal end of the optical fiber on a subject; and an elongated outer cylinder that accommodates the optical fiber scanner and the illumination lens.

A third aspect of the present invention is an observation apparatus including: the above-described illuminator; and a light-detecting part that, when the illuminator irradiates the subject with the illumination light, detects return light returning from the subject.

### REFERENCE SIGNS LIST

1, 101, 102, 103 Optical fiber scanner
2 Optical fiber
2a Distal end
2b Optical scanning section (distal-end portion)
3 Elastic member (oscillation-conveying part)
4A, 4B, 4C, and 4D Driving piezoelectric element
5A and 5B Detecting piezoelectric element
6 Control unit
7 Fixing member
8A, 8B Driving lead wire
9 GND lead wire
10 Detecting lead wire
11 Electroconductive part
12 Adhesive
20 Illuminator
21 Illumination lens
22 Outer cylinder
23 Light source
31 Detecting optical fiber
32 Photodetector
100 Observation apparatus
L Illumination light
L′ Return light
X Subject

1. An optical fiber scanner comprising:
an elongated optical fiber that is capable of guiding light and emitting the light from a distal end thereof;
a driving piezoelectric element that is provided on an outer circumferential surface of the optical fiber and that, when an alternating voltage is applied thereto, produces bending oscillation in a direction intersecting a longitudinal direction of the optical fiber at a distal-end portion of the optical fiber as a result of expanding and contracting in the longitudinal direction;
a detecting piezoelectric element provided on an outer circumferential surface at the distal-end portion of the optical fiber; and
a control unit that applies the alternating voltage to the driving piezoelectric element and controls the alternating voltage on the basis of a voltage produced by the detecting piezoelectric element.

2. The optical fiber scanner according to claim 1, wherein the detecting piezoelectric element is provided at at least one of two positions on the outer circumferential surface of the optical fiber, the two positions facing each other in a direction in which the distal-end portion undergoes the bending oscillation.

3. The optical fiber scanner according to claim 2, wherein a pair of the detecting piezoelectric elements are provided at both of the two positions.

4. The optical fiber scanner according to claim 1, further comprising: an oscillation-conveying part composed of a tubular elastomer provided between the outer circumferential surface of the optical fiber and the driving piezoelectric element.

5. The optical fiber scanner according to claim 1, further comprising: a tubular electroconductive part that is provided between the outer circumferential surface at the distal-end portion of the optical fiber and the driving and detecting piezoelectric elements and that is electrically connected to the driving piezoelectric element and the detecting piezoelectric element.

6. The optical fiber scanner according to claim 1, wherein the detecting piezoelectric element is provided over substantially the entire length of the distal-end portion.

7. An illuminator comprising:
the optical fiber scanner according to claim 1;
a light source that is disposed at a base-end side of the optical fiber scanner and supplies illumination light to the optical fiber;
an illumination lens that is disposed at a distal-end side of the optical fiber scanner and focuses the illumination light emitted from the distal end of the optical fiber on a subject; and
an elongated outer cylinder that accommodates the optical fiber scanner and the illumination lens.

8. An observation apparatus comprising:
the illuminator according to claim 7; and
a light-detecting part that, when the illuminator irradiates the subject with the illumination light, detects return light returning from the subject.
